(19) United States
(12) Patent Application Publication
(10) Pub. No.: US 2025/0062580 A1
(43) Pub. Date: Feb. 20, 2025

(54) Connector Rotating Device

(71) Applicant: Tyco Electronics (Shanghai) Co., Ltd., Shanghai (CN)

(72) Inventors: Jianguo (Thomas) Yang, Shanghai (CN); Lijiong Zhang, Shanghai (CN)

(73) Assignee: Tyco Electronics (Shanghai) Co., Ltd., Shanghai (CN)

(21) Appl. No.: 18/807,287

(22) Filed: Aug. 16, 2024

(30) Foreign Application Priority Data
Aug. 18, 2023 (CN) 202311049959.X

(51) Int. Cl. H01R 43/18

(52) U.S. Cl. CPC H01R 43/18

(57) ABSTRACT

A connector rotating device includes a first rotating module, a second rotating module, and a third rotating module. The first rotating module is adapted to rotate a first connector from a first initial orientation to a first predetermined orientation different from the first initial orientation. The second rotating module is adapted to rotate a second connector from a second initial orientation to a second predetermined orientation different from the second initial orientation. The third rotating module is adapted to rotate the second connector from the second predetermined orientation to a third predetermined orientation different from the second predetermined orientation. The second rotating module and the third rotating module are arranged side by side in a first horizontal direction. The first rotating module is spaced by a predetermined distance from the second rotating module and the third rotating module in a vertical direction.

### CROSS-REFERENCE TO RELATED APPLICATION

This application claims the benefit of Chinese Patent Application No. CN202311049959.X filed on Aug. 18, 2023, in the State Intellectual Property Office of China, the whole disclosure of which is incorporated herein by reference.

### FIELD OF THE DISCLOSURE

The present disclosure relates to a connector rotating device.

### BACKGROUND

In the manufacturing process of connectors, it is necessary to rotate the connector to the predetermined orientation in order to insert the cable into the socket on the connector. In the prior art, the connector rotation device can only perform one type of connector rotation operation. Therefore, the existing connector rotation device cannot be applied to the rotation operation of different connectors. This severely limits the applicability of the connector rotating device.

### SUMMARY

According to an embodiment of the present disclosure, a connector rotating device includes a first rotating module, a second rotating module, and a third rotating module. The first rotating module is adapted to rotate a first connector from a first initial orientation to a first predetermined orientation different from the first initial orientation. The second rotating module is adapted to rotate a second connector from a second initial orientation to a second predetermined orientation different from the second initial orientation. The third rotating module is adapted to rotate the second connector from the second predetermined orientation to a third predetermined orientation different from the second predetermined orientation. The second rotating module and the third rotating module are arranged side by side in a first horizontal direction. The first rotating module is spaced by a predetermined distance from the second rotating module and the third rotating module in a vertical direction.

### BRIEF DESCRIPTION OF THE DRAWINGS

The disclosure will now be described by way of example with reference to the accompanying Figures, of which:

FIG. 1 shows an illustrative perspective view of a connector rotating device according to an exemplary embodiment of the present invention when viewed from one side;

FIG. 2 shows an illustrative perspective view of a connector rotating device according to an exemplary embodiment of the present invention when viewed from the other side;

FIG. 3 shows a vertical sectional view of a connector rotating device according to an exemplary embodiment of the present invention;

FIG. 4 shows an illustrative perspective view of a connector rotating device according to an exemplary embodiment of the present invention, wherein the first rotating module is moved to a working position; and

FIG. 5 shows an illustrative perspective view of a connector rotation device according to an exemplary embodiment of the present invention, wherein the second and third rotating modules are moved to the working position.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a connector rotating device comprises: 1) a first rotating module which is used to rotate a first connector from a first initial orientation to a first predetermined orientation different from the first initial orientation; 2) a second rotating module which is used to rotate a second connector from a second initial orientation to a second predetermined orientation different from the second initial orientation; and 3) a third rotating module is used to rotate the second connector from the second predetermined orientation to a third predetermined orientation different from the second predetermined orientation. The second rotating module and the third rotating module are arranged side by side in a first horizontal direction. The first rotating module is spaced by a predetermined distance from the second rotating module and the third rotating module in a vertical direction.

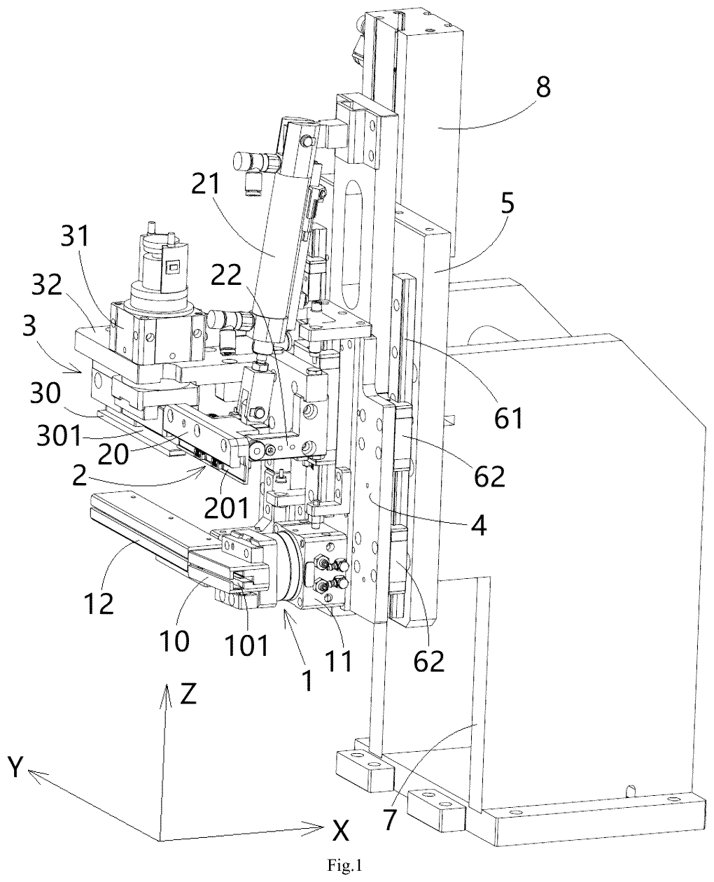

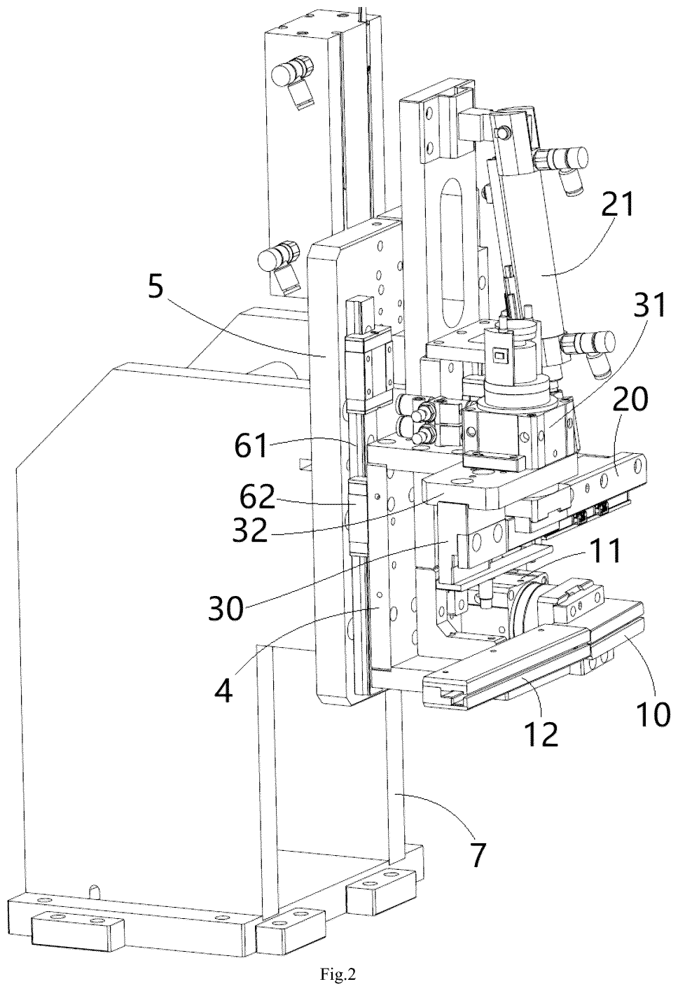

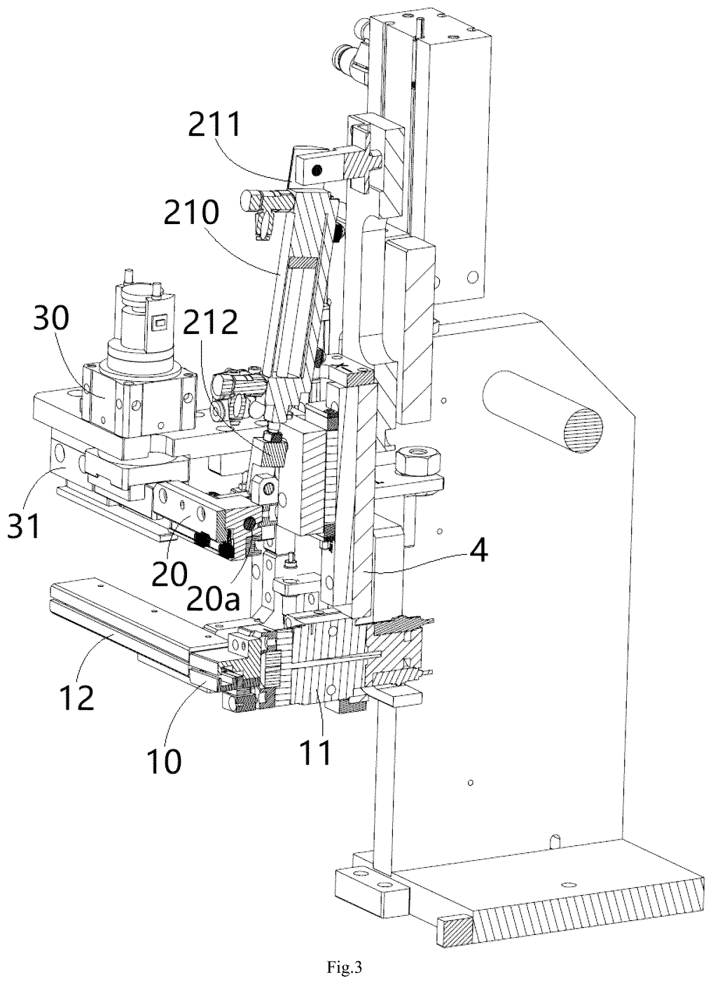

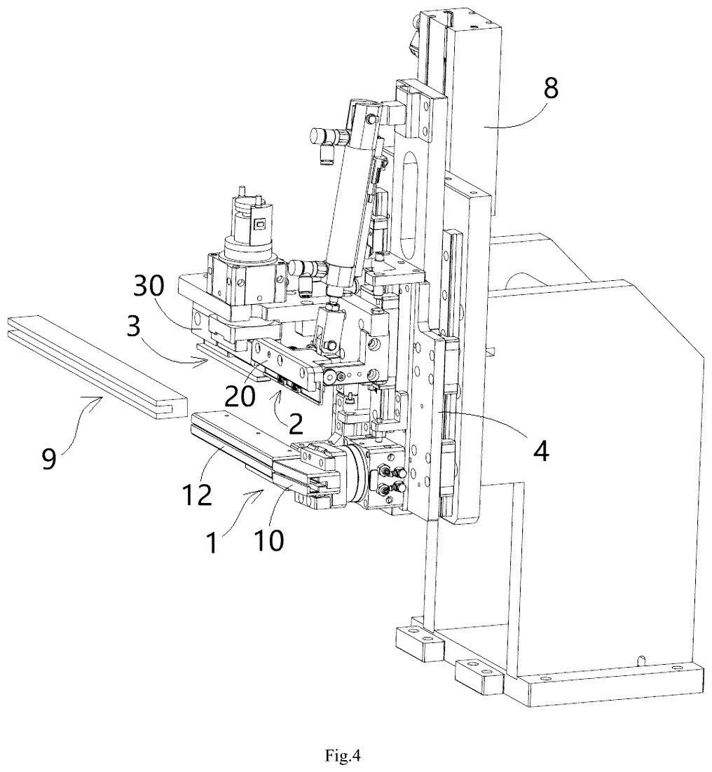

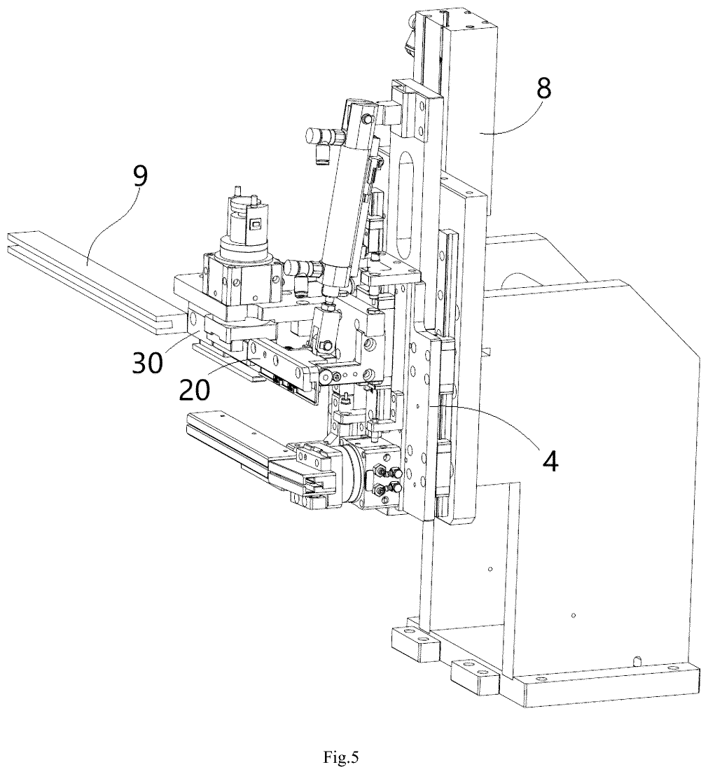

FIG. 1 shows an illustrative perspective view of a connector rotating device according to an exemplary embodiment of the present invention when viewed from one side. FIG. 2 shows an illustrative perspective view of a connector rotating device according to an exemplary embodiment of the present invention when viewed from the other side. FIG. 3 shows a vertical sectional view of a connector rotating device according to an exemplary embodiment of the present invention. FIG. 4 shows an illustrative perspective view of a connector rotation device according to an exemplary embodiment of the present invention, wherein the first rotating module 1 is moved to a working position. FIG. 5 shows an illustrative perspective view of a connector rotation device according to an exemplary embodiment of the present invention, wherein the second rotating module 2 and the third rotating module 3 are moved to the working position.

As shown in FIGS. 1-5, in an exemplary embodiment of the present disclosure, a connector rotating device is disclosed. The connector rotating device includes a first rotating module 1, a second rotating module 2, and a third rotating module 3. The first rotating module 1 is adapted or used to rotate a first connector (not shown) from a first initial orientation to a first predetermined orientation different from the first initial orientation. The second rotating module 2 is adapted or used to rotate a second connector (not shown) from a second initial orientation to a second predetermined orientation different from the second initial orientation. The third rotating module 3 is used to rotate the second connector from the second predetermined orientation to a third predetermined orientation different from the second predetermined orientation.

The second rotating module 2 and the third rotating module 3 are arranged side by side in the first horizontal direction Y to enable the second connector to be rotated in sequence. The first rotating module 1 is spaced by a predetermined distance in the vertical direction Z from the second rotating module 2 and the third rotating module 3 to ensure that the first rotating module 1 does not interfere with the second rotating module 2 and the third rotating module 3 during rotation.

The first rotating module 1 rotates the first connector around a first axis, and the first axis extends along a second horizontal direction X perpendicular to the first horizontal direction Y. The second rotating module 2 rotates the second connector around a second axis, and the second axis extends along the first horizontal direction Y. The third rotating module 3 rotates the second connector around a third axis, and the third axis extends in the vertical direction Z.

In the illustrated embodiments, when the first rotating module 1 rotates the first connector from the first initial orientation to the first predetermined orientation, the first rotating module 1 rotates 180 degrees around the first axis. When the second rotating module 2 rotates the second connector from the second initial orientation to the second predetermined orientation, the second rotating module 2 rotates 90 degrees around the second axis. When the third rotating module 3 rotates the second connector from the second predetermined orientation to the third predetermined orientation, the third rotating module 3 rotates 180 degrees around the third axis.

In an exemplary embodiment of the present invention, the shape and size of the first connector and the second connector are identical, the direction of the cable socket in the first connector is different from that of the cable socket in the second connector. For example, the axial direction of the cable socket in the first connector is parallel to the longitudinal direction of the first connector, and the axial direction of the cable socket in the second connector is perpendicular to the longitudinal direction of the second connector. The first rotating module 1 is used to rotate the cable socket in the first connector to a predetermined orientation, in order to insert the cable into the cable socket in the first connector. The second rotating module 2 and the third rotating module 3 are used to rotate the cable socket in the second connector to a predetermined orientation, in order to insert the cable into the cable socket in the second connector.

The connector rotating device further comprises a movable plate 4, which can be moved between a first position and a second position in the vertical direction Z. The first rotating module 1, the second rotating module 2, and the third rotating module 3 are installed on the movable plate 4 to move together with the movable plate 4. When the movable plate 4 is moved to the first position (as shown in FIG. 4), the first rotating module 1 is moved to the working position docked with the transmission channel 9, the second rotating module 2 and the third rotating module 3 are moved to a non-working position separated from the transmission channel 9. When the movable plate 4 is moved to a second position (as shown in FIG. 5), the first rotating module 1 is moved to the non-working position separate from the transmission channel 9, and the second rotating module 2 and the third rotating module 3 are moved to the working position docked with the transmission channel 9. After the first or second connector is rotated, the transmission channel 9 transport the first or second connector to the next processing station, such as the cable insertion station and the terminal crimping station.

The connector rotating device further comprises a fixed plate 5, a slide rail 61, and a slider 62. The slide rail 61 is fixed to the fixed plate 5 and extends in the vertical direction Z. The slider 62 slidably mounted onto the slide rail 61 to move along it. The movable plate 4 is connected to the slider 62 to be able to move along the vertical direction Z with the slider 62.

The connector rotating device further comprises a driver 8. The driver 8 is installed on the fixed plate 5 for driving the movable plate 4 to move between the first and second positions. In an exemplary embodiment of the present invention, the driver 8 may be an electric cylinder, a pneumatic cylinder, or a hydraulic cylinder. The connector rotating device further comprises a frame 7. The fixed plate 5 is fixed to the frame 7.

The first rotating module 1 comprises a first carrier 10 and a first driver 11. The first carrier 10 is used to load the first connector. The first driver 11 is installed on the movable plate 4. The first carrier 10 has a first loading channel 101 for loading the first connector, and the first driver 11 is connected to the first carrier 10 for driving the first carrier 10 to rotate around the first axis.

The first rotating module 1 further includes a connection channel 12, which is fixed to the movable plate 4. When the first carrier 10 rotates the first connector from the first initial orientation to the first predetermined orientation, the first loading channel 101 of the first carrier 10 is docked with the connection channel 12 to allow the first connector to be transported from the first loading channel 101 to the connection channel 12. When the first rotating module 1 is moved to the working position, the connection channel 12 is docked with the transmission channel 9 to allow the first connector to be transported from the connection channel 12 to the transmission channel 9. The first driver 11 can be a motor, and the first carrier 10 is connected to the output shaft of the motor.

The second rotating module 2 comprises a second carrier 20 and a second driver 21. The second carrier 20 is used to load the second connector. The second driver 21 is installed on the movable plate 4. The second carrier 20 has a second loading channel 201 for loading the second connector, and the second driver 21 is connected to the second carrier 20 for driving the second carrier 20 to rotate around the second axis. The second rotating module 2 further includes an installation bracket 22, which is fixed to the movable plate 4. The second carrier 20 has a pivot shaft 20a, which is rotatably installed on the installation bracket 22, allowing the second carrier 20 to rotate around the second axis. In the illustrated embodiments, the second driver 21 is a cylinder, and one end 211 of the cylinder block 210 of the cylinder is rotationally connected to the movable plate 4. The telescopic rod 212 of the cylinder extends out of the other end of the cylinder block 210 and is rotationally connected to the second carrier 20.

The third rotating module 3 comprises a third carrier 30 and a third driver 31. The third carrier 30 is used to load the second connector. The third driver 31 is installed on the movable plate 4. The third carrier 30 has a third loading channel 301 for loading the second connector, and the third driver 31 is connected to the third carrier 30 for driving the third carrier 30 to rotate around the third axis. The third rotating module 3 further includes an installation plate 32, which is fixed to the movable plate 4. The third driver 31 is a motor and is installed on the installation plate 32, and the output shaft of the motor is connected to the third carrier 30.

When the second carrier 20 rotates the second connector from the second initial orientation to the second predetermined orientation, the second loading channel 201 on the second carrier 20 is docked with the third loading channel 301 on the third carrier 30 to allow the second connector to be transported from the second loading channel 201 to the third loading channel 301. When the second rotating module 2 and the third rotating module 3 are moved to the working position and the third rotating module 3 rotates the second connector to the third predetermined orientation, the third loading channel 301 is docked with the transmission channel 9 to allow the second connector to be transported from the third loading channel 301 to the transmission channel 9.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector rotating device, comprising:
a first rotating module adapted to rotate a first connector from a first initial orientation to a first predetermined orientation different from the first initial orientation;
a second rotating module adapted to rotate a second connector from a second initial orientation to a second predetermined orientation different from the second initial orientation; and
a third rotating module adapted to rotate the second connector from the second predetermined orientation to a third predetermined orientation different from the second predetermined orientation, the second rotating module and the third rotating module are arranged side by side in a first horizontal direction, and the first rotating module is spaced by a predetermined distance from the second rotating module and the third rotating module in a vertical direction.

2. The connector rotating device according to claim 1, wherein:
wherein the first rotating module rotates the first connector around a first axis, and the first axis extends along a second horizontal direction perpendicular to the first horizontal direction; and
the second rotating module rotates the second connector around a second axis extending along the first horizontal direction, the third rotating module rotates the second connector around a third axis extending along the vertical direction.

3. The connector rotating device according to claim 2, wherein:
when the first rotating module rotates the first connector from the first initial orientation to the first predetermined orientation, the first rotating module rotates 180 degrees around the first axis;
when the second rotating module rotates the second connector from the second initial orientation to the second predetermined orientation, the second rotating module rotates 90 degrees around the second axis; and
when the third rotating module rotates the second connector from the second predetermined orientation to the third predetermined orientation, the third rotating module rotates 180 degrees around the third axis.

4. The connector rotating device according to claim 2, further comprising a movable plate movable between a first position and a second position in the vertical direction, wherein the first rotating module, the second rotating module, and the third rotating module are installed on the movable plate to move together with the movable plate, wherein:
when the movable plate is moved to the first position, the first rotating module is moved to a working position docked with a transmission channel, the second rotating module and the third rotating module are moved to a non-working position separated from the transmission channel; and
when the movable plate is moved to the second position, the first rotating module is moved to a non-working position separate from the transmission channel, the second rotating module and the third rotating module are moved to the working position docked with the transmission channel.

5. The connector rotating device according to claim 4, further comprising:
a fixed plate;
a slide rail fixed to the fixed plate and extending in the vertical direction; and
a slider slidably installed on the slide rail and adapted to move along the slide rail, wherein the movable plate is connected to the slider and is adapted to move along the vertical direction with the slider.

6. The connector rotating device according to claim 5, further comprising a driver installed on the fixed plate to drive the movable plate to move between the first position and the second position.

7. The connector rotating device according to claim 6, wherein the driver is an electric cylinder, a pneumatic cylinder, or a hydraulic cylinder.

8. The connector rotating device according to claim 6, further comprising a frame on which the fixed plate is fixed.

9. The connector rotating device according to claim 4, wherein the first rotating module comprises:
a first carrier adapted to load the first connector; and
a first driver installed on the movable plate, wherein the first carrier has a first loading channel adapted for loading the first connector, and the first driver is connected to the first carrier for driving the first carrier to rotate around the first axis.

10. The connector rotating device according to claim 9, wherein the first rotating module further comprises a connection channel fixed to the movable plate, wherein when the first carrier rotates the first connector from the first initial orientation to the first predetermined orientation, the first loading channel of the first carrier is docked with the connection channel to allow the first connector to be transported from the first loading channel to the connection channel.

11. The connector rotating device according to claim 10, wherein when the first rotating module is moved to the working position, the connection channel is docked with the transmission channel to allow the first connector to be transported from the connection channel to the transmission channel.

12. The connector rotating device according to claim 9, wherein the first driver is a motor, and the first carrier is connected to an output shaft of the motor.

13. The connector rotating device according to claim 4, wherein the second rotating module comprises:
a second carrier adapted for loading the second connector; and
a second driver installed on the movable plate, wherein the second carrier has a second loading channel for loading the second connector, and the second driver is connected to the second carrier for driving the second carrier to rotate around the second axis.

14. The connector rotating device according to claim 13, wherein the second rotating module further comprises an installation bracket fixed to the movable plate, the second carrier has a pivot shaft which is rotatably mounted on the installation bracket to enable the second carrier to rotate around the second axis.

15. The connector rotating device according to claim 14, wherein the second driver is a cylinder, and one end of the cylinder body of the cylinder is rotatably connected to the movable plate, a telescopic rod of the cylinder extends out of the other end of the cylinder body and is rotatably connected to the second carrier.

16. The connector rotating device according to claim 13, wherein the third rotating module comprises:
a third carrier adapted to load the second connector; and
a third driver installed on the movable plate, wherein the third carrier has a third loading channel for loading the second connector, and the third driver is connected to the third carrier for driving the third carrier to rotate around the third axis.

17. The connector rotating device according to claim 16, wherein the third rotating module further comprises an installation plate fixed to the movable plate.

18. The connector rotating device according to claim 17, wherein the third driver is a motor and is installed on the installation plate, and an output shaft of the motor is connected to the third carrier.

19. The connector rotating device according to claim 18, wherein when the second carrier rotates the second connector from the second initial orientation to the second predetermined orientation, the second loading channel on the second carrier is docked with the third loading channel of the third carrier to allow the second connector to be transported from the second loading channel to the third loading channel.

20. The connector rotating device according to claim 19, wherein when the second rotating module and the third rotating module are moved to the working position and the third rotating module rotates the second connector to the third predetermined orientation, the third loading channel is docked with the transmission channel to allow the second connector to be transported from the third loading channel to the transmission channel.
